(19) United States
(12) Patent Application Publication
(10) Pub. No.: US 2003/0179917 A1
(43) Pub. Date: Sep. 25, 2003

(54) Method for image presentation in medical imaging

(75) Inventors: Roland Faber, Uttenreuth (DE); Oliver Schreck, Bamberg (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/391,146

(22) Filed: Mar. 18, 2003

(30) Foreign Application Priority Data
Mar. 25, 2002 (DE) 10213284.4

(51) Int. Cl. G06K 9/00

(52) U.S. Cl. 382/130

(57) ABSTRACT

In a method for image presentation in medical imaging, whereby image data obtained with a first range of contrast from an imaging measurement are converted into image data having a second range of contrast and are presented on a medium with the second range of contrast. An image class from a predefined group of different image classes is automatically determined from auxiliary information about the image and/or the measurement obtained with the image data from the imaging measurement, and the conversion is implemented with parameters allocated to the image class. This allows an automated conversion of the range of contrast for an optimum presentation of the image on a medium, so that the filming of the images can ensue automatically without further interaction of the operating personnel.

### BACKGROUND OF THE INVENTION

1. Field of the Invention

The present invention is directed to a method for image presentation in medical imaging, of the type wherein image data obtained with a first range of contrast from an imaging measurement are converted into image data having a second range of contrast and are presented on a medium with the second range of contrast.

2. Description of the Prior Art

Medical imaging represents a significant branch of medical diagnostics. Images of the inside of an examination subject can be acquired and presented on an appropriate medium by means of methods such as computed tomography, magnetic resonance tomography or sonography. Currently, the image data obtained from imaging measurements are available almost exclusively in digital form.

For example, image data can be obtained in the 12-bit format with the medical devices such as, for example, computed tomograms or magnetic resonance tomograms utilized for acquiring the measured data, so that the grayscale range of these image data has 4096 grayscale levels. The high range of contrast of the image data obtained from the imaging measurement must be suitably converted into a lower range of contrast that typically has 8 bits, i.e. 256 grayscale levels. A simple linear mapping of the high range of contrast onto the lower range of contrast is generally not desired since this can lead to an unjustifiable loss of information in the image regions of interest. In the case of computed tomography image data, for example, only intensity values or grayscale values that lie within a relatively narrow grayscale range are of interest in certain applications for the display of individual organs. For loss-free image presentation of such image regions on a medium, thus, an excerpt from the range of contrast of the image data is selected that lies within this relatively narrow grayscale range and which has a width that, for example, corresponds to 256 grayscale levels or less. This type of conversion of the range of contrast by selecting an excerpt is referred to as windowing. Intensity values or grayscale values that are higher than the upper window value are reproduced white on the medium; intensity values or grayscale values that are lower than the lower window values are reproduced black.

Another possibility for the conversion of the range of contrast is the utilization of a conversion table (LUT: lookup table) that enables a non-linear conversion of the range of contrast. Each grayscale value of the source image data is allocated to a table entry that raises or lowers this specific grayscale value by means of a mathematical operation. Not only a windowing or contrast compression but also an arbitrary change of the contrast characteristic within the image data can be implemented in this way.

Conventionally, the conversion of the range of contrast of the image data obtained from the imaging measurement has been manually carried out by the operating personnel of the corresponding imaging device. Dependent on the image type or the nature of the imaging measurement, the operating personnel or the diagnosing physician as well defines the position and window width of the windowing for the presentation on the corresponding medium. In magnetic resonance tomography, however, this requires a considerable part of the work time since the actual diagnosis in this field continues to be implemented by viewing sheets of film and all images must be viewed before filming and have their range of contrast adapted. A dependable, automatic windowing of the range of contrast of the image data that are obtained therefore would offer considerable advantages.

Known methods for automatic windowing, however, have not yet been able to prevail since they are incapable of delivering acceptable results for the multiple, different image types that exist. The known methods are based on an analysis of the grayscale values of the obtained image data, a contrast compression then being implemented on the basis thereof. One example of this is the method of histogram homogenizing.

German OS 197 42 118 discloses a method for the conversion of the range of contrast of digital image data wherein the local image regions of the image are taken into consideration in the image analysis. This method, as well, requires an analysis of the grayscale value range of the image data wherein an evaluation of the background, a mask generation as well as a parameter estimate are implemented and interpreted for the conversion of the range of contrast in order to compress the contrast region of topically slowly changing regions of the image and essentially retain fine structures.

However, as with other known methods, this method does not lead to satisfactory results for the user or diagnosing physician given all existing image types and also involves considerable calculating outlay.

### SUMMARY OF THE INVENTION

An object of the present invention is to provide a method for image presentation in medical imaging with which an automatic conversion of the range of contrast of the image data that are obtained is possible in a simple way, with an optimum result for the user for a number of image types.

This object is achieved in accordance with the inventive method for image presentation in medical imaging, wherein image data obtained with a first range of contrast from an imaging measurement are converted into image data having a second range of contrast and are presented on a medium with the second range of contrast, and wherein an image class from a predefined group of different image classes is automatically determined from auxiliary information about the image and/or the measurement obtained with the image data from the imaging measurement, and the conversion is implemented with parameters allocated to the image class.

This method allows medical imaging systems to be configured such that they achieve reproducible results. This is achieved by a system adjustment that, dependent on the type of adjustment or setting, is already implemented by the manufacturer, at regular intervals by service personnel, or by the operating personnel before every measurement. In any case, this system adjustment assures that currently employed imaging devices deliver reproducible results. This also applies to the range of contrast of the image data obtained with these devices that are independent of patients subjected to the imaging measurement. Approximately the same contrast for the presentation of the same body regions is thus always obtained dependent on the measuring method employed and on the image type or the evaluation method of the measured data that leads to the image.

The present method also makes use of auxiliary information that indicates at least the measuring method, for example the measurement sequence employed, as well as the image type. The auxiliary information is also obtained with the image data from the imaging measurement. The auxiliary information about the image and/or the measurement is utilized in the present method in order to assign the image data to an image class from a predefined group of different image classes. The parameters for the conversion of the range of contrast of image data of an image class were determined in advance for each of the different image classes. This determination becomes possible because of the reproducibility of the imaging measurements. The conversion is implemented with these parameters determined in advance for the respective image class, the parameters being able to be optimally defined for each image class.

The classification of the obtained image in combination with the previously defined parameters for each image class is that the image data for each class to be respectively automatically obtained from the number of possible measuring methods or image types with an optimum range of contrast for the use. In particular, the contrast differences between the results of different measuring methods and evaluation methods or the image types resulting from the evaluation methods are taken into consideration. For example, it is important that only the vessels be presented in an MIP image of the head, i.e., in an image type with a projection of maximum intensity, whereas the vessels must be relegated to the background in an image type for the presentation of the gray or white brain matter in the same area. A distinction can be made between these two image types by evaluating the auxiliary information obtained with the image data, and the respectively optimum conversion of the range of contrast, particularly an optimum windowing, can be automatically achieved.

In contrast to the known methods wherein the parameters for the conversion of the range of contrast are determined by an analysis of the grayscale distribution of the image, the present method does not implement an image analysis. On the contrary, the auxiliary data appended to the image data obtained from an imaging measurement are evaluated. The auxiliary information usually is present in the header of the dataset. The DICOM standard, which contains such auxiliary information in the header, has thereby prevailed in medical imaging. DICOM (Digital Imaging and Communications in Medicine) is a specific standard for radiology that is valid worldwide. It was designed according to the OSI model, the Open System Interconnection model that allows communication between heterogeneous systems. Different imaging and image-processing devices can exchange images and data using this standard. DICOM standardizes the structure of the formats and descriptive parameters for radiological images and commands for exchanging these images and also standardizes the description of other data objects such as image sequences, examination series and findings.

Before implementing the present method, a classification of the images obtained from different measuring and evaluation methods into individual image classes must be implemented. This can ensue, for example, by generating a feature space, wherein individual regions are combined to image classes, from the auxiliary information respectively communicated together with the obtained images. After the division into image classes, the parameters for the conversion of the range of contrast that lead to a presentation on the corresponding medium that is optimum for the later diagnosis are defined for each image class. This can ensue, for example, by indicating the position and the breadth of a grayscale region within the grayscale of the range of contrast for a windowing. Different window values usually are allocated to different image classes.

Of course, a conversion with the assistance of LUTs alternatively can be implemented dependent on image class. In this case, a separate LUT is allocated to each of the corresponding image classes, the results desired for the conversion of this image class being realized with the LUT.

The division of the multitude of different measuring and evaluation methods or image types as well as the allocation of the parameters to the individual image classes is preferably undertaken in advance manually by trained technical personnel. After the definition of the image classes, the features in the auxiliary information corresponding to the image classes as well as the parameters allocated to the individual image classes, these results can be utilized for all imaging measurements. The classification and parameterization can be implemented globally for all systems as well as selectively for individual system types, for example computed tomograms and magnetic resonance tomograms. The number of definable images classes is also arbitrary. It is self-evident that better results.are achieved given definition of a greater number of image classes than given definition of a relatively small number of image classes.

In another embodiment, the classification and parameterization is automatically undertaken by a self-educating system, for example a neural network. It is required that, given initially occurring mismatches, the operator can correct the parameters of the conversion according to the operator's wishes. The self-educating system acquires the corrections and takes these into consideration in the prescription of the image classes and allocated parameters. In this case, these parameters are not permanently fixed from the outset but are adapted or refined by the self-educating system during the operation of the respective imaging system. This enables an individual adaptation to the respective needs or wishes of the operator. A person-specific prescription of the image classes and allocated parameters can also be realized by means of such a system.

The present method enables the automatic conversion of the range of contrast or grayscale values of the image data obtained from an imaging measurement, particularly the automatic windowing and avoids a time-consuming and cost-intensive post-processing of the images by an operator. The filming of the images that is still required in many instances can ensue automatically and without further interaction of the operating personnel as a result of the present method. The specific needs or wishes of the diagnosing physicians are taken into consideration by means of an optional, individual adaptation feature of the method.

### DESCRIPTION OF THE DRAWINGS

FIG. 1 is a flowchart for the implementation of the present method.

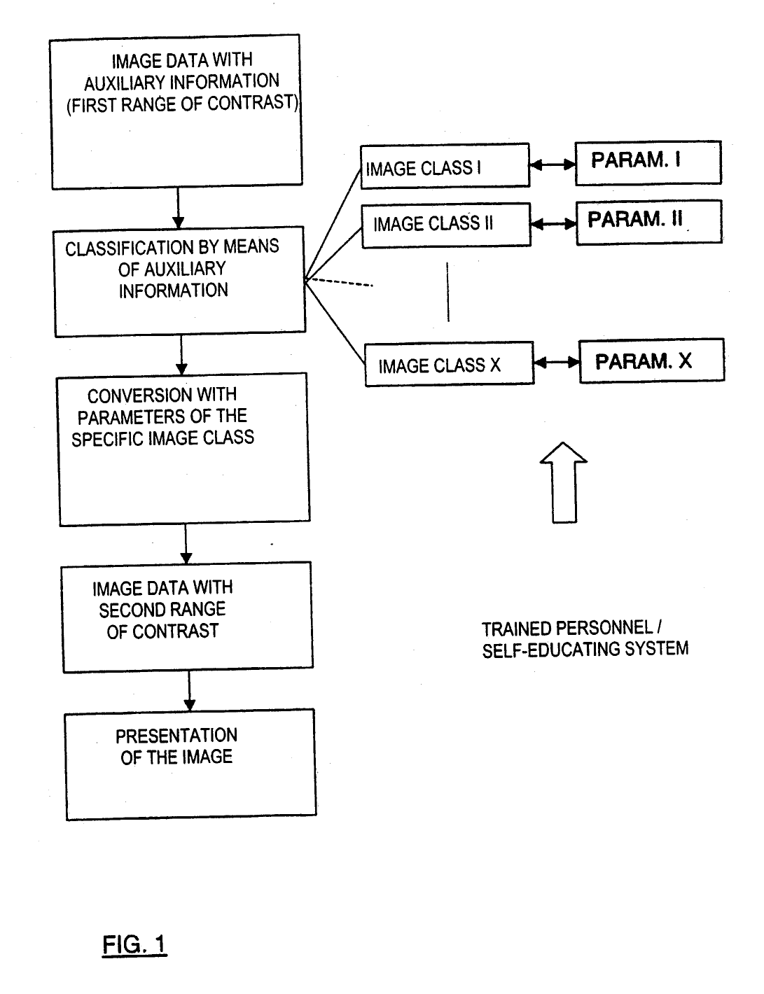

FIG. 2 illustrates an example of a windowing with different parameter values.

### DESCRIPTION OF THE PREFERRED EMBODIMENTS

In the exemplary embodiment, the image data of a magnetic resonance tomography measurement are obtained in the DICOM format. The image data have a range of contrast of 12 bits, i.e. 4096 grayscale values, as included in the standard in a number of imaging measuring methods. Of course, image data having a range of contrast other than 12 bits, for example higher than 12 bits, also can be converted with the present method.

The auxiliary information about the measuring method underlying the obtained image data as well as about the evaluation method that leads to the image data or the image type are read out from the DICOM header and compared to corresponding features in a memory wherein the features are allocated to individual image classes I, II, . . . X. The image class belonging to the auxiliary information that has been read out is determined from this comparison. The features in the auxiliary information can be, for example, details about the DICOM image type, an indication of a measurement with or without contrast agent, information such as the sequence utilized in the measurement, about the repetition time, the echo time, the body region or T2*. For example, T1-weighted images, T2-weighted images, images in echoplanar technique (EPI) or MIP images are possibilities as different image classes. This enumeration, of course, is not exclusive and can be arbitrarily expanded according to the available magnetic resonance measuring methods and measured data evaluation methods. Parameters PI, PII, . . . PX are allocated to each image class I, II, . . . X, said parameters enabling the conversion of the range of contrast of the obtained image data of this image class into a different range of contrast, particularly by windowing, with which the image data are optimally presented for the diagnosis to be implemented. In the case of a windowing, the parameters PI, PII, . . . PX respectively allocated to the respective image classes each include the position C (center) and width W within the grayscale of the source image data that were obtained.

After the determination of the image class for the obtained image data, the conversion of the range of contrast according to the parameters allocated to this image class ensues in the present method. Finally, the image data with the modified, usually lower, range of contrast obtained in this way are presented on the presentation medium, for example a monitor.

The same method steps are applied to image data that are obtained by means of other imaging measuring methods such as, for example, computed tomography (CT) or X-ray angiography (AX). Given such image data, the features that can be set forth in the auxiliary data can be, for example, the DICOM image type, the indication of the tube voltage as well as of the current utilized in the measurement, the filter thickness of an AI filter that is employed, the anode type or the indication as to whether the measurement was implemented with or without contrast agent. All of these features influence the contrast obtained in the image and may possibly require different parameters for the conversion of the range of contrast. For example, contrast images, MIP images or SSD images come into consideration as image classes given such X-ray exposures. This, of course, is not an all-inclusive enumeration. Those skilled in the art can suitably select the image classes according to the different parameters required for the presentation. The division into individual image classes as well as the allocation of the parameters preferably is implemented on a one-time basis in advance by trained personnel and is then available in a memory of the system for all measurements implemented with the system. Optionally, a self-educating system can be integrated that adapts the allocation as well as the selection of the parameters given a correction by the user and in conformity with the preferences that can be derived therefrom.

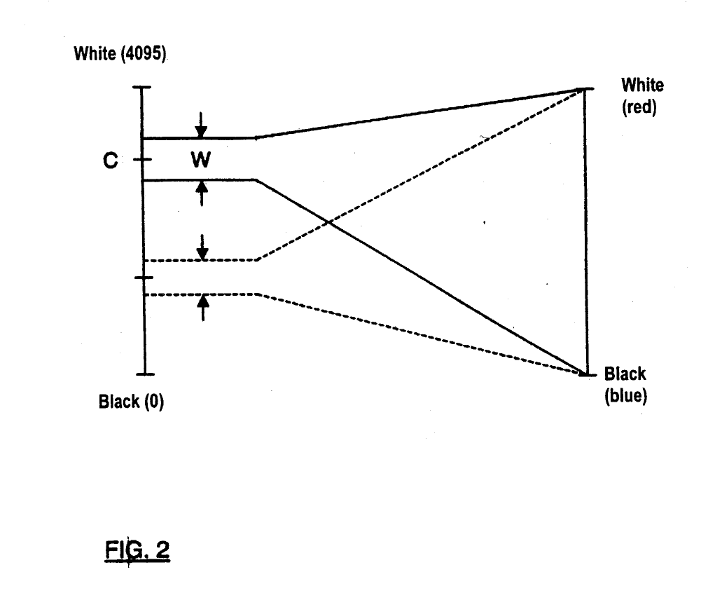

As an example, FIG. 2 shows the technique of windowing for converting image data of a first range of contrast of, for example, 12 bits into a second range of contrast of, for example, 8 bits for two different image classes. The bar at the left represents the 4096 grayscale values of the image data obtained from the imaging measurement, with the value 0 corresponding to the gray level of black and the value 4095 corresponds to the gray level of white. When such an image is to be displayed at a monitor having a grayscale of 8 bits, i.e. 256 grayscale levels, as represented by the bar at the right, then a corresponding conversion of the range of contrast must be implemented.

In the windowing, a range of grayscale values within the grayscale of the image data having the position C and the width W is selected that is mapped onto the entire range of luminance of the monitor by means of a corresponding spread. This is schematically indicated in FIG. 2. In this way, for example, a range of contrast having the width W of 256 grayscale levels can be displayed at the monitor with maximum contrast resolution. Grayscale values of the original image data above C+W/2 are displayed here as white on the monitor, those below C-W/2 are displayed as black. Other conversion parameters, i.e. a different position C and width W, can be required given the presence of image data of a different image class in order to obtain a presentation result that is optimum for this image class. This is shown in FIG. 2 by the dotted line, which corresponds to these other conversion parameters.

In one possible embodiment, the two grayscale ranges selected in FIG. 2 can be simultaneously displayed at the monitor in different colors, for example red and blue, so that a viewer can discriminate between the two ranges on the basis of the color presentation.

By means of a suitable prescription, the image data can be fundamentally classified in a number of image classes with the present method, different parameters for the conversion of the range of contrast that are optimum for the respective image class being respectively allocated to these classes. The classification of the images or image data on the basis of the auxiliary information, as well as the conversion with the respectively allocated parameters, can ensue fully automatically. Of course, the ability for the user to make corrections can also be provided, if the user wishes a presentation result that differs from the optimum conversion of the range of contrast.

In the same way, the conversion or compression of the range of contrast can also be realized by prescribing LUTs that are applied to the corresponding image data. A separate LUT can also be allocated to each image class as conversion parameter.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for presenting a medical image comprising the steps of:
predefining a group of image classes of images respectively obtained by medical imaging measurements;
converting an image obtained with a first range of contrast from one of said medical imaging measurements into image data having a second range of contrast by automatically determining one of said image classes from auxiliary information describing at least one of said image and said medical imaging measurement, and obtaining conversion parameters from the automatically determined class, and converting said image data having said image data having said first range of contrast into said image data having a second range of contrast using said parameters; and
presenting said image data having said second range of contrast.

2. A method as claimed in claim 1 comprising converting said image data having said first range of contrast into said image data having said second range of contrast by windowing, with said parameters representing a center and width within a gray scale corresponding to said first range of contrast.

3. A method as claimed in claim 1 wherein the step of converting said image data having a first range of contrast into said image data having a second range of contrast comprises non-linearly adapting said data having said first range of contrast using a conversion table, with said parameters represented by said conversion table.

4. A method as claimed in claim 3 comprising allocating different colors for presenting said image data having said second range of contrast, to different gray scale ranges of said first range of contrast dependent on said conversion table.

5. A method as claimed in claim 1 comprising manually determining said predefined group of image classes.

6. A method as claimed in claim 1 comprising determining said predefined group of image classes using a self-educated computerized system.

7. A method as claimed in claim 1 comprising allowing manual modification of said parameters.

8. A method as claimed in claim 1 comprising determining said image class from said predefined group of image classes by comparing features contained in said auxiliary information to a table stored in a memory wherein different features are allocated respectively to said different image classes.
